(19) United States
(12) Patent Application Publication
(10) Pub. No.: US 2015/0302138 A1
(43) Pub. Date: Oct. 22, 2015

(54) NATURAL GAS DEHYDRATION VESSEL HAVING REDUCED REGENERATION MODE CYCLE TIME AND METHOD OF USE AND DESIGN THEREOF

(71) Applicants: Lee David Rhyne, Cypress, TX (US); Jacob Andrew Cohen, Houston, TX (US); Christopher Allen Bennett, Cypress, TX (US)

(72) Inventors: Lee David Rhyne, Cypress, TX (US); Jacob Andrew Cohen, Houston, TX (US); Christopher Allen Bennett, Cypress, TX (US)

(73) Assignee: Chevron U.S.A. Inc., San Ramon, CA (US)

(21) Appl. No.: 14/256,151

(22) Filed: Apr. 18, 2014

(51) Int. Cl. G06F 17/50; B01D 53/02; G06F 17/10; B01D 53/00

(52) U.S. Cl. CPC G06F 17/5086; B01D 53/002; B01D 53/02; G06F 17/10; B01D 2253/116; B01D 2257/80

(57) ABSTRACT

A vessel for dehydrating a natural gas stream using molecular sieve material contained therein and a method for designing such a vessel are described. The vessel includes cylindrical vessel walls having a plurality of thermally conductive plates attached to the inner surface thereof. The plurality of thermally conductive plates are distributed vertically and circumferentially through the cylindrical portion of the vessel. The dimensions of the thermally conductive plates can be determined using computational fluid dynamics analysis of a process for regenerating the molecular sieve material. It is possible to reduce the duration of operation in regeneration mode using the vessel of the present disclosure.

### FIELD

The present disclosure relates to vessels useful for the dehydration of natural gas, and to methods for the design and the use thereof.

### BACKGROUND

During the processing of natural gas, it is frequently necessary to subject the natural gas to a dehydration step in order to remove water vapor. This is conventionally done by passing a natural gas feed through a vessel containing a bed of molecular sieve material known to be effective at adsorbing water molecules.

As plant capacities have increased, such dehydration vessels have been sized to handle increased volumes of gas at very high pressures. For instance, vessel walls have become thicker and overall vessel dimensions have become larger. Operational difficulties related to inefficient heat transfer between the interior of the vessel and the vessel walls have resulted from the increasing vessel dimensions. The heat transfer is primarily conduction type heat transfer through the regeneration gas since the flow of the hot regeneration gas is laminar in the molecular sieve bed. Laminar, conductive heat transfer is highly inefficient in gas since the thermal conductivity and the specific heat of gas are very low.

It would be desirable to have a natural gas dehydration vessel which would avoid the aforementioned difficulties.

### SUMMARY

In one aspect, an apparatus for dehydrating a natural gas is provided. The apparatus includes vessel walls defining a vessel volume enclosed therein, a first opening in the vessel, a second opening in the vessel, and a plurality of thermally conductive plates attached to the vessel walls partially projecting into the vessel volume.

In another aspect, a method for dehydrating natural gas utilizing the apparatus is provided. The method includes feeding natural gas into a first opening in a vessel comprising vessel walls defining a vessel volume enclosed therein and having a plurality of thermally conductive plates attached to the vessel walls partially projecting into the vessel volume, wherein the vessel is at least partially filled with a plurality of molecular sieve pellets, such that the natural gas flows over the molecular sieve pellets and water vapor is adsorbed by the molecular sieve pellets and removing dehydrated natural gas from a second opening in the vessel. When the molecular sieve pellets adsorb a predetermined amount of water, the feeding of the natural gas is discontinued. At this point, hot regeneration gas having a temperature between about 150° C. and about 500° C. is fed into the second opening in the vessel such that the regeneration gas flows over the molecular sieve pellets and water is removed from the molecular sieve pellets and carried by the regeneration gas through the first opening of the vessel whereby the molecular sieve pellets are dried. When the molecular sieve pellets are dried, the feeding of the hot regeneration gas is discontinued. Cool regeneration gas having a temperature between about 10° C. and about 100° C. is then fed into the second opening in the vessel such that the regeneration gas flows over the molecular sieve pellets and through the first opening of the vessel and the molecular sieve pellets are cooled to a temperature between about 10 and about 100 degrees C.

In another aspect, a method for designing an apparatus for dehydrating natural gas is provided. The method for designing the apparatus includes an initial step of performing a computational fluid dynamics analysis of a system for dehydrating natural gas in a vessel comprising vessel walls defining a vessel volume enclosed therein to determine a wall thermal boundary layer thickness, wherein the computational fluid dynamics analysis includes inputting at least one predetermined value selected from the group consisting of vessel diameter, vessel length, vessel wall thickness, regeneration gas temperature and regeneration gas flow rate to be utilized in the system. Thermally conductive plates to be attached to the vessel walls are then designed such that the thermally conductive plates have a minimum radial penetration of from one to four times the thermal boundary layer thickness.

### DESCRIPTION OF THE DRAWINGS

These and other objects, features and advantages of the present invention will become better understood with reference to the following description, appended claims and accompanying drawings where:

FIG. 1 is a cutaway view illustrating a vessel for dehydrating natural gas according to the prior art.

FIG. 2A is a cutaway view illustrating a vessel for dehydrating natural gas according to one exemplary embodiment.

FIG. 2B is a cross-sectional view illustrating a vessel for dehydrating natural gas according to one exemplary embodiment.

FIG. 3 is an exemplary view of computational fluid dynamics analysis output of a system for dehydrating natural gas.

### DETAILED DESCRIPTION

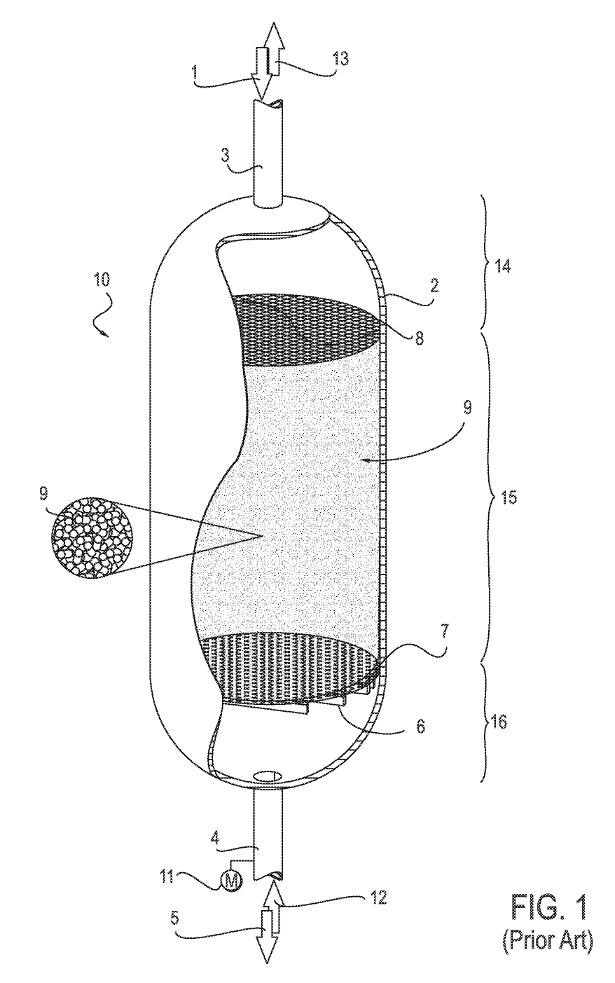

FIG. 1 is a cutaway view of a vessel 10 for dehydrating natural gas according to the prior art. The vessel is enclosed by a vessel wall 2, and can be considered to consist of a cylindrical portion 15 having a top end and a bottom end, a top head 14 and a lower head 16. The top head 14 includes a top opening 3, and the lower head 16 includes a lower opening 4. Girders 6 are provided proximate the bottom end of the cylindrical portion 15 to provide structural support to support the weight of a bed of molecular sieve pellets 9. A lower screen 7 is located directly above the girders 6 to prevent pellets 9 from passing into the lower head 16, thereby containing the pellets 9 in the vessel 10. An upper screen 8 is located above the pellets 9. The upper screen 8 can be free to float vertically while resting on the bed of pellets 9. Other vessel designs for dehydrating natural gas are known. Some designs avoid the use of girders and screens as shown in FIG. 1. For instance, in some known vessels, the molecular sieve pellets are supported by inert ceramic balls.

During normal operation mode, a feed stream of natural gas 1 is provided at ambient temperature to the top opening 3 and flows downwardly through the bed of molecular sieve pellets 9. Water vapor in the feed stream is adsorbed by the pellets 9, and dehydrated natural gas 5 flows from the lower opening 4. Over time, the molecular sieve pellets 9 become increasingly saturated with water and ineffective at adsorbing moisture, and the natural gas leaving the vessel 5 from the lower opening 4 contains an increasing amount of water vapor. The amount of moisture in the natural gas 5 leaving the vessel is monitored by a sensor 11. When a predetermined maximum desired amount of moisture in the natural gas 5 leaving the vessel is reached and detected by the sensor 11, normal operation is discontinued, meaning the flow of feed gas 1 is discontinued. At this point, operation is shifted to regeneration mode.

During regeneration mode, a feed stream of hot regeneration gas 12 is provided to the lower opening 4 and flows upwardly through the molecular sieve pellets 9. Moisture from the pellets 9 is carried by the regeneration gas 12 up and out of the vessel 10 through the top opening 3 as gas stream 13. Operation continues in regeneration mode until a predetermined desired amount of moisture in the regeneration gas 13 leaving the vessel is reached, indicating that the molecular sieve pellets 9 have become dry to the point that the pellets 9 are effective at adsorbing moisture from the natural gas. At this point, operation switches to cooling mode in which cool gas is introduced to the vessel through lower opening 4 until the temperature within the vessel is sufficiently cooled to resume normal operation.

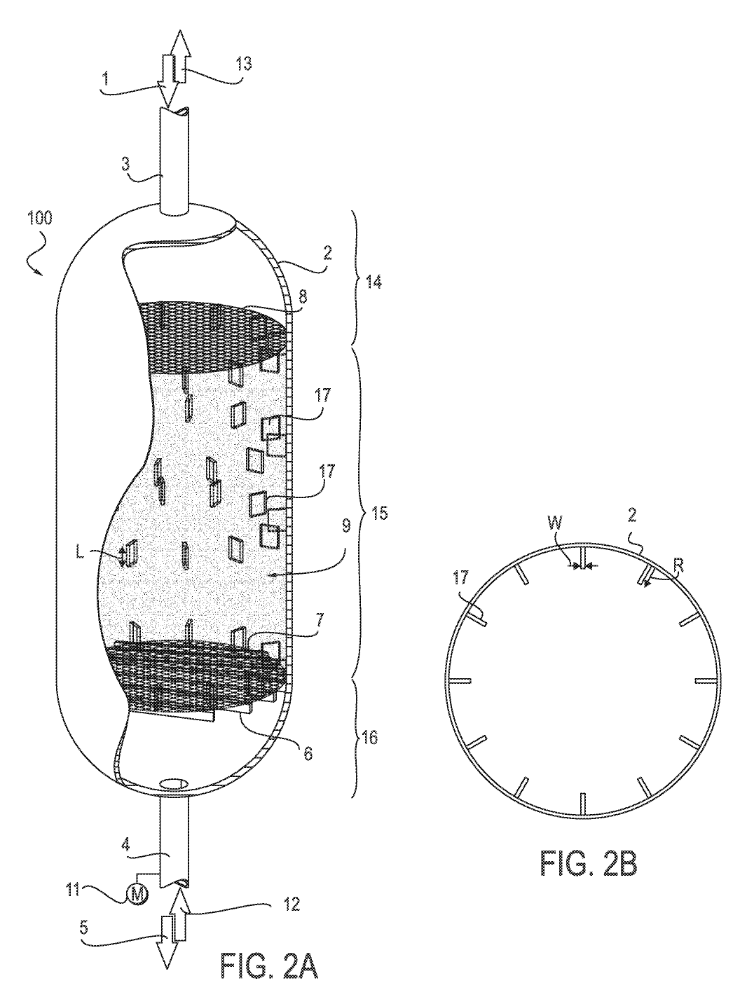

FIG. 2A and FIG. 2B illustrate a cutaway view and a cross-sectional view, respectively, of a vessel 100 according to one embodiment of the present disclosure. Like numerals refer to like elements among all of the drawings. In one embodiment, an apparatus for dehydrating a natural gas includes a vessel comprising vessel walls defining a vessel volume enclosed therein, a first opening in the vessel, a second opening in the vessel, and a plurality of thermally conductive plates attached to the vessel walls partially projecting into the vessel volume.

While various shapes and sizes are possible, one embodiment of a vessel according to the present disclosure is shown in FIG. 2A. As seen in FIG. 2A and FIG. 2B, thermally conductive plates 17 are attached to the interior surface of the vessel wall 2 within the cylindrical portion 15 of the vessel 100. It has been found that by providing the vessel 100 with a plurality of thermally conductive plates 17 attached to the vessel wall 2 in such a way that heat may be conducted from the thermally conductive plates 17 to the vessel wall 2, the time required for regeneration mode can advantageously be decreased. Not wishing to be bound by theory, it is believed that heat transfer from the hot regeneration gas 12 to the vessel wall 2 is enhanced by the presence of the thermally conductive plates 17, and that this results in more efficient regeneration of the molecular sieve pellets 9.

In one embodiment, the vessel wall 2 can have a thickness from about 50 to about 500 mm. In one embodiment, the vessel 100 has a height between about 1 and about 10 m and a diameter between about 1 and about 8 m, and each of the thermally conductive plates 17 has a width W between about 1 and about 50 mm, a radial penetration R between about 1 and about 1000 mm, and a length L between about 1 and about 4000 mm. In one embodiment, the thermally conductive plates 17 are spaced between about 100 and about 3000 mm apart circumferentially around the vessel.

FIG. 2A and FIG. 2B illustrate one embodiment in which the thermally conductive plates 17 attached to the interior surface of the vessel wall 2 such that the thermally conductive plates 17 are generally vertical, and thus are oriented substantially parallel to the design gas flow, i.e., parallel to the direction of the flow of gas in use as designed. By “substantially parallel” it is meant within 45° of parallel. In another embodiment, not shown, the thermally conductive plates 17 can be generally horizontal and thus are oriented substantially perpendicular to the design gas flow. By “substantially perpendicular” it is meant within 45° of perpendicular.

The thermally conductive plates 17 can have a variety of suitable individual shapes and sizes. FIG. 2A illustrates thermally conductive plates 17 having a generally rectangular shape. Other polygonal shapes are also suitable. The thermally conductive plates 17 can be attached to the vessel wall 2 by any suitable method that provides secure attachment and acceptable thermal contact. The thermally conductive plates 17 are formed of the same material as the vessel wall or a material with higher thermal conductivity that will conduct the heat to the vessel wall 2. The thermally conductive plates 17 can have equal or greater chemical resistivity to the feed stream 1.

The thermally conductive plates 17 can be attached on the vessel wall 2 in a regular, orderly pattern. In one embodiment, the vertical and/or horizontal spacing between the plates 17 is uniform. In another embodiment, the placement of the plates 17 can be determined by analytical tools such as finite element analysis and computational fluid dynamics.

In one embodiment, a method for operating the vessel 100 is provided. During normal operation mode, also referred to as dehydration mode, a feed stream of natural gas 1 is provided at ambient temperature to the top opening 3 and flows downwardly through the bed of molecular sieve pellets 9. During dehydration mode, the temperature can range from about 10 to about 100 degrees C. and a pressure can range from about 20 to about 100 bar(g).

Water vapor in the feed stream is adsorbed by the pellets 9, and dehydrated natural gas 5 flows from the lower opening 4. Over time, the molecular sieve pellets 9 become increasingly saturated with water, and the natural gas leaving the vessel 5 from the lower opening 4 contains an increasing amount of water vapor. The amount of moisture in the natural gas 5 leaving the vessel is monitored by a sensor 11. When a predetermined maximum desired amount of moisture in the natural gas 5 leaving the vessel is reached and detected by the sensor 11, normal operation is discontinued, meaning the flow of feed gas 1 is discontinued. At this point, operation is shifted to regeneration mode.

During regeneration mode, a feed stream of hot regeneration gas 12 is provided to the lower opening 4 and flows upwardly through the plurality of molecular sieve pellets 9. Moisture from the pellets 9 is carried by the regeneration gas 12 up and out of the vessel 10 through the top opening 3 as gas stream 13. During regeneration mode, the temperature in the vessel 100 can range from about 10 to about 500 degrees C. The regeneration gas 12 has a temperature between about 150 and about 500 degrees C. The regeneration gas 12 flows at a flow rate between about 10,000 and about 200,000 normal cubic meters per hour. Operation continues in regeneration mode until a predetermined desired amount of moisture in the regeneration gas 13 leaving the vessel is reached, indicating that the molecular sieve pellets 9 have become dry to the point that the pellets 9 are effective at adsorbing moisture from the natural gas. At this point, operation switches to cooling mode in which cool gas at a temperature between about 10 and about 100 degrees C. is introduced to the vessel through lower opening 4 until the temperature within the vessel is sufficiently cooled to resume normal operation, i.e. cooled to a temperature between about 10 and about 100 degrees C.

In one embodiment, operation in dehydration mode is conducted for from about 1 to about 100 hours, and operation in regeneration mode is conducted for from about 1 to about 20 hours.

In one embodiment, operation in dehydration mode is conducted for a duration from about 1 and about 10 times a combined duration of regeneration mode and cooling mode.

In one embodiment, a method for designing a vessel 100 for dehydrating natural gas is provided. Engineering analysis is conducted to determine the thickness of a wall thermal boundary layer, also referred to as a wall thermal boundary layer thickness. In one embodiment, a computational fluid dynamics (CFD) analysis of a system for dehydrating natural gas in a vessel comprising vessel walls defining a vessel volume enclosed therein is conducted to determine the wall thermal boundary layer thickness. Commercially available CFD software such as ANSYS Fluent (ANSYS, Inc., Canonsburg, Pa.) can be used to generate an analysis of the condition of the molecular sieve bed after regeneration.

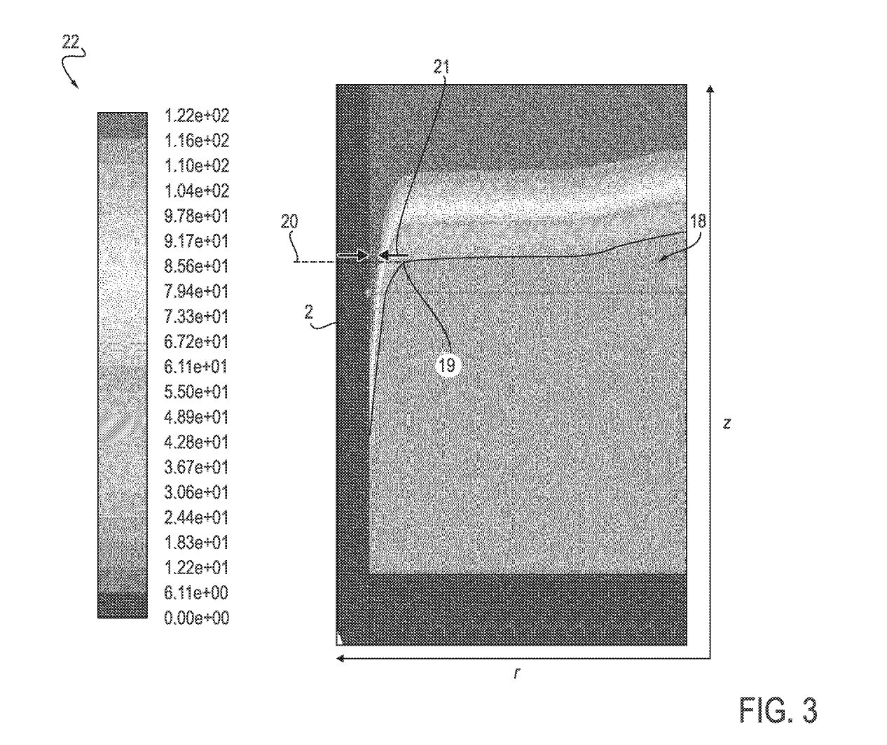

An example of an image generated by the software is shown in FIG. 3, in which the amount of adsorbed water (in kilograms per cubic meter) within a vessel, having no thermally conductive plates attached to the vessel wall, after regeneration is shown at the boundary with the vessel wall 2. Legend 22 indicates the amount of adsorbed water in kilograms per cubic meter for each color provided with the output (each color is represented by a different black and white pattern for the purposes of this disclosure). The image shown is a partial view of a cross-section of the vessel 100 wherein the cross-section is taken through the axis of the vessel 100. At this stage of the design procedure, the wall boundary layer 21 is being determined on vessel 100 prior to determining the size and position of appropriate thermally conductive plates 17, thus the thermally conductive plates 17 are not shown. The right-hand vertical edge of the image represents the center axis of the vessel. The center axis is represented by z. The left-hand vertical edge and the bottom horizontal edge of the image represent the vessel wall. The radial axis is represented by r. FIG. 3 illustrates the output of the CFD software for an exemplary system in which regeneration gas flows from the bottom of the vessel upward through the molecular sieve bed. The vessel wall 2 is 8 inches (20 cm) thick in the exemplary design. The bottom of the molecular sieve bed has steel girders supporting the bed and a screen to prevent molecular sieve material from falling into the bottom head of the vessel. Laid on top of the screen is a layer of ceramic balls ½ inch (1.3 cm) diameter, another layer of ¼ inch (0.6 cm) diameter, and a third layer of ⅛ inch (0.3 cm) diameter ceramic balls. Above the layers of ceramic balls is a molecular sieve bed containing 1/16th inch (0.1 cm) cylindrical molecular sieve pellets.

As evidence of the presence of a thermal boundary layer along the vessel wall 2 in FIG. 3, the sections of the various colors, indicating different levels of water adsorbed, are not horizontal bands of color extending from the center of the vessel (the right-hand side of the image as shown in FIG. 3) to the wall, but rather deviate downward from the horizontal to form a shoulder 19. The thermal boundary layer thickness is determined herein as the thickness 21 of the layer adjacent to the wall 2 when a horizontal line 20 is extended to the vessel wall 2 from the shoulder 19. Reference numeral 18 indicates the volume within the vessel which is hot dry gas. Since hot regeneration gas enters the vessel at the bottom, there is no boundary layer at the bottom and the boundary layer gets thicker as you go higher within the vessel. This is because the heat in the hot regeneration gas is transferred to the vessel wall, and higher up within the vessel, the gas further inside the vessel must transfer heat to the intermediate layers between the center of the vessel and the wall. The intermediate layers in turn transfer heat to the vessel wall but act as impedance. Over time, the vessel wall at the bottom of the vessel becomes hotter than the vessel wall at the top of the vessel.

The actual state of the molecular sieve bed will depend on the duration (amount of time in hours) of regeneration and on the flow rate and temperature used during regeneration mode, as well as the thickness of the vessel wall, the thermal properties of the molecular sieve bed and the vessel, and the shape and size of the molecular sieve material. The CFD analysis includes inputting at least one predetermined value selected from the group consisting of vessel diameter, vessel length, vessel wall thickness, regeneration gas temperature and regeneration gas flow rate to be utilized in the system into the software. The analysis of boundary layer conditions thereby generated includes the thickness of the wall thermal boundary layer. In one embodiment, the thickness of the wall thermal boundary layer 21 is used to determine the minimum radial penetration R of the thermally conductive plates 17 as described herein (as shown in FIG. 2B).

In one embodiment, the thermally conductive plates 17 have a radial penetration R of from one to four times the boundary layer thickness 21 and a length L of from one to four times the radial penetration R (as shown in FIG. 2B).

It should be noted that only the components relevant to the disclosure are shown in the figures, and that many other components normally part of a gas dehydration system are not shown for simplicity.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. An apparatus for dehydrating a natural gas, comprising:
a. a vessel comprising vessel walls defining a vessel volume enclosed therein;
b. a first opening in the vessel;
c. a second opening in the vessel; and
d. a plurality of thermally conductive plates attached to the vessel walls partially projecting into the vessel volume.

2. The apparatus of claim 1, wherein the vessel walls comprise a substantially cylindrical portion having an upper end and a lower end, a top head for enclosing the upper end of the cylindrical portion and a lower head for enclosing the lower end of the cylindrical portion; the first opening is in the top head; and the second opening is in the lower head.

3. The apparatus of claim 1, further comprising a meter for monitoring moisture content of natural gas leaving the second opening in the vessel.

4. The apparatus of claim 1, wherein the vessel walls have a thickness from about 50 to about 500 mm.

5. The apparatus of claim 1, wherein the plurality of thermally conductive plates are attached to the vessel walls by welding.

6. The apparatus of claim 1, wherein the plurality of thermally conductive plates are attached to the vessel walls by clamping.

7. The apparatus of claim 1, wherein the vessel walls and the plurality of thermally conductive plates are formed of a common material.

8. The apparatus of claim 1, wherein the plurality of thermally conductive plates comprise a thermally conductive material.

9. The apparatus of claim 2, wherein the vessel has a height between about 1 and about 10 m and a diameter between about 1 and about 8 m, and each of the plurality of thermally conductive plates has a width W from about 1 to about 50 mm, a radial penetration R from about 1 to about 1000 mm, and a length L from about 1 to about 4000 mm.

10. The apparatus of claim 2, wherein the plurality of thermally conductive plates are spaced between about 10 and about 3000 mm apart circumferentially around the vessel.

11. A method for dehydrating natural gas, comprising:
a. feeding natural gas into a first opening in a vessel comprising vessel walls defining a vessel volume enclosed therein and having a plurality of thermally conductive plates attached to the vessel walls partially projecting into the vessel volume, wherein the vessel is at least partially filled with a plurality of molecular sieve pellets, such that the natural gas flows over the molecular sieve pellets and water vapor is adsorbed by the molecular sieve pellets and removing dehydrated natural gas from a second opening in the vessel;
b. discontinuing step (a) when the molecular sieve pellets adsorb a predetermined amount of water;
c. feeding regeneration gas having a temperature between about 150° C. and about 500° C. into the second opening in the vessel such that the regeneration gas flows over the molecular sieve pellets and water is removed from the molecular sieve pellets and carried by the regeneration gas through the first opening of the vessel whereby the molecular sieve pellets are dried; and
d. feeding regeneration gas having a temperature between about 10° C. and about 100° C. into the second opening in the vessel such that the regeneration gas flows over the molecular sieve pellets and through the first opening of the vessel and the molecular sieve pellets are cooled to a temperature between about 10 and about 100 degrees C.

12. The method of claim 11, wherein step (a) is conducted for between about 1 and about 100 hours; and step (c) is conducted for between about 1 and about 20 hours.

13. The method of claim 11, wherein step (a) is conducted for a duration between about 1 and about 10 times a combined duration of steps (c) and (d).

14. The method of claim 11, wherein step (a) is conducted at a temperature between about 10 and about 100 degrees C. and a pressure between about 20 and about 100 bar(g); and step (c) is conducted at a temperature between about 10 and about 500 degrees C.

15. The method of claim 11, wherein the regeneration gas has a temperature between about 150 and about 500 degrees C.; and the regeneration gas flows at a flow rate between about 10,000 and about 200,000 normal cubic meters per hour.

16. A method for designing an apparatus for dehydrating natural gas, comprising:
a. performing a computational fluid dynamics analysis of a system for dehydrating natural gas in a vessel comprising vessel walls defining a vessel volume enclosed therein to determine a wall thermal boundary layer thickness, wherein the computational fluid dynamics analysis includes inputting at least one predetermined value selected from the group consisting of vessel diameter, vessel length, vessel wall thickness, regeneration gas temperature and regeneration gas flow rate to be utilized in the system; and
b. designing thermally conductive plates to be attached to the vessel walls such that the thermally conductive plates have a minimum radial penetration of one times the wall thermal boundary layer thickness.

16. The method of claim 15, wherein the thermally conductive plates each have a thermally conductive plate radial penetration R of from one to four times the thermal boundary layer thickness and a thermally conductive plate length L of from one to four times the thermally conductive plate radial penetration R.

17. The method of claim 15, wherein the thermally conductive plates are designed to be attached to the vessel walls such that the thermally conductive plates are oriented substantially parallel to a design gas flow.

18. The method of claim 15, wherein the thermally conductive plates are designed to be attached to the vessel walls such that the thermally conductive plates are oriented substantially perpendicular to a design gas flow.
